(19) United States
(12) Patent Application Publication
(10) Pub. No.: US 2005/0115355 A1
(43) Pub. Date: Jun. 2, 2005

(54) Pedal

(75) Inventor: Hans-Werner Stender, Bochum (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Edscha Betaetigungssysteme GmbH, Hengersberg (DE)

(21) Appl. No.: 10/909,490

(22) Filed: Aug. 2, 2004

Related U.S. Application Data
(60) Provisional application No. 60/502,000, filed on Sep. 11, 2003.

(30) Foreign Application Priority Data
Aug. 1, 2003 (DE) DE 103 35 403.4

(51) Int. Cl. G05G 1/14

(52) U.S. Cl. 74/560

(57) ABSTRACT

A pedal for a vehicle includes a pedal body having a first pedal arm and a second pedal arm. An adjustment unit including a toothing is arranged at the pedal body. An elongated hole, oriented parallel to the toothing, is disposed at one of the first pedal arm and the second pedal arm and a roller disposed at the other of the first pedal arm and the second pedal arm, and arranged in the elongated hole. The first pedal arm is adjustable relative to the second pedal arm by intermeshing of the toothing.

The invention relates to a pedal for a vehicle according to the preamble of claim 1, comprising a pedal body which has a first pedal arm and a second pedal arm, and an adjustment unit which is arranged on the pedal body and which has at least one toothing, the first pedal arm being adjustable in relation to the second pedal arm by intermeshing of the toothing.

U.S. Pat. No. 6,151,986 discloses an adjustable pedal in which a first pedal arm is arranged on a bearing block so as to be rotatable about an axial pin, the bearing block having two openings in which the axial pin is rotatably mounted. In addition, an adjustable second pedal arm is provided which is arranged on the first pedal arm and which can be pivoted about a joint pin with respect to the first pedal arm. The adjustable second pedal arm has, at the end facing away from the joint pin, a tread surface. In an upper section, having the joint pin, of the controllable second pedal arm an elongated hole is formed in which a sliding block is movably arranged, the sliding block being guided in the elongated hole by means of a shaft. The sliding block has an opening with an internal thread. At the end of the elongated hole facing away from the joint pin, the upper section has an opening, the opening in the section and the opening in the sliding block being penetrated by a lever screw which is provided with a thread. At one end, the lever screw is attached to the first pedal arm by means of two supports. A pinion, which engages in an intermeshing fashion with a worm thread which is formed on the axial pin, is formed between the two supports on the lever screw. The axial pin has, at one end, a gear mechanism which intermeshes with a gearwheel. The gearwheel is connected to an engine via a control cable. A disadvantage with this type of pedal is the fact that the adjustment unit has a complicated design and is thus susceptible to malfunction so that the pedal can then only be adjusted to a restricted degree, or cannot be adjusted at all anymore. In addition, the large number of components makes the manufacturing process complex and therefore costly. It is also disadvantageous that the adjustable pedal arm can be pivoted or adjusted about a joint pin which is arranged on the first pedal arm, giving rise to a restricted adjustment range, which is limited to a pivoting circle for the tread surface so that a desired pedal position cannot be set for all persons.

The object of the invention is to specify a pedal according to the preamble of claim 1 which permits reliable adjustment and activation.

This object is achieved according to the invention with the pedal mentioned at the beginning by means of the defining features of claim 1, wherein the toothing is arranged at the first pedal arm, and wherein the first pedal arm is moveable along the toothing.

The two pedal arms can be adjusted with respect to one another by means of intermeshing of the toothing, as a result of which the effective length of the entire pedal body can be adapted individually for different users. By virtue of the different lengths of the pedal body, a different lever arm for activating the pedal is also provided, the force which is produced in order to activate the pedal and the force which is transmitted by the pedal always being the same. The pedal body must have sufficient strength and rigidity for any length in order to reliably absorb and transmit the forces which occur. In order to be able to obtain the same degree of rigidity of the two pedal arms for any length of the pedal body, according to the invention an elongated hole which is arranged on one of the pedal arms is provided, a roller which is provided on the other pedal arm being arranged in the elongated hole, as a result of which the two pedal arms are reliably guided with respect to one another during the adjustment so that the pedal body has a high degree of strength and rigidity for any length of the pedal body, permitting reliable activation of the pedal.

Advantageously arranging the toothing on the first pedal arm makes it possible, on the one hand, for the first pedal arm to be connected directly to the adjustment unit, as a result of which an adjustment force which is to be transmitted from the adjustment unit to the first pedal arm without significant losses, which may arise, for example, due to friction or the like, is transmitted. The force which is to be applied to adjust the pedal arm is thus reduced and can be provided by a person activating the adjustment unit in an easy way, for example by turning a screw or the like. Motorized support of the adjustment unit is not necessary. On the other hand, a complicated design of the adjustment unit on the pedal body is avoided so that the adjustment unit is not susceptible to malfunctions caused by individual components, and reliable adjustment of the pedal arm is carried out.

In one preferred embodiment, the toothing has a curved profile, as a result of which the pedal can advantageously be adjusted on a curved line. This has the advantage that the pedal can not only be moved in relation to a driver, forwards or rearwards or upwards or downwards, but also can be moved in both directions simultaneously so that when there are different drivers with different leg lengths the pedal can be moved as required into the position which is preferred by the driver, and is thus the ideal one. The adjustability of the pedal into an ideal position enables the pedal to be activated safely, thus permitting the vehicle to be driven safely. The curved profile of the toothing is not restricted to a specific arc of a circle, with the result that, for example, a radius of the toothing may be formed in a progressive or degressive fashion in order to provide a greater degree of variability for the position of the pedal in a desired range.

The adjustment unit advantageously has a gearwheel element which is coupled to a worm wheel, the gearwheel element and the worm wheel being provided in a housing which is embodied as a separate component. This ensures that the adjustment unit can be manufactured easily and without a large degree of effort. In addition, when a malfunction of the adjustment unit occurs, this permits the problem to be easily eliminated, for example by replacing the faulty part. To do this all that is necessary is to release the housing in which the adjustment unit is provided from the pedal and to replace it with a new one. There is thus no need for costly installation and removal of the pedal arm to be adjusted, or even of the entire pedal. A costly period of time at a workshop for a defective adjustment unit to be replaced is thus avoided since the adjustment unit can be replaced by anyone simply and easily.

In one advantageous embodiment, the second pedal arm is formed from a first part and a second part, the first pedal arm being advantageously arranged between the two parts. This provides the advantage that the two pedal arms are secured in relation to one another, the first pedal arm which is to be adjusted being reliably secured between the two parts of the second pedal arm, as a result of which the two pedal arms can be securely connected in any position which is provided by the adjustment of the two pedal arms. Furthermore, the secure connection of the two pedal arms ensures that the pedal can be activated safely.

The adjustment unit advantageously has a guide which is arranged on the second pedal arm, as a result of which the adjustment distance of the first pedal arm is predefined unambiguously during the adjustment, and the first pedal arm is prevented from tilting with respect to the second pedal arm, the guide being expediently of multicomponent construction.

Further advantages and features of the invention emerge from the following description and from the dependent claims.

The invention is explained in more detail below with reference to the appended drawings and by means of a preferred exemplary embodiment of a pedal according to the invention, in which:

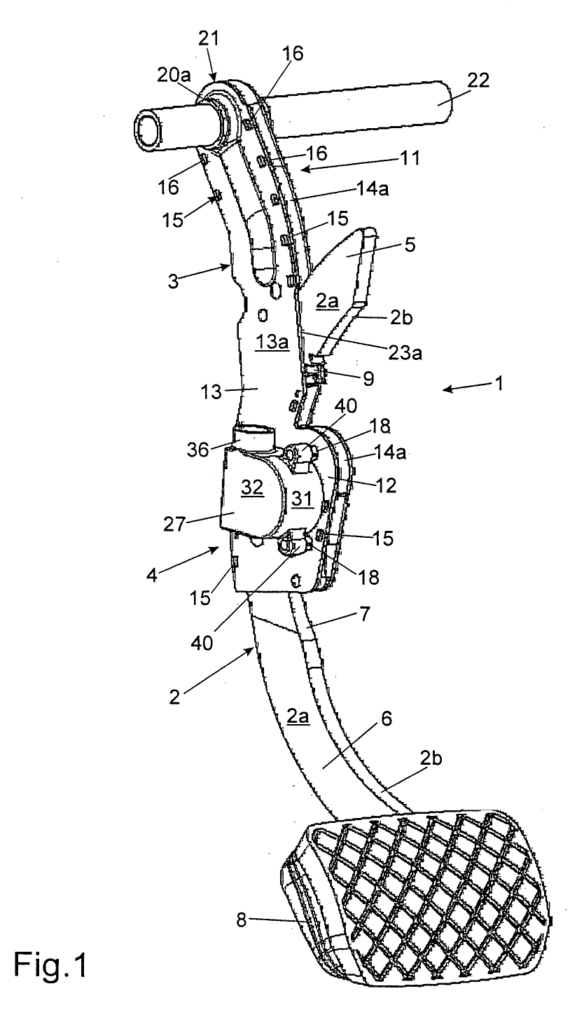

FIG. 1 shows a perspective view of the exemplary embodiment of a pedal according to the invention,

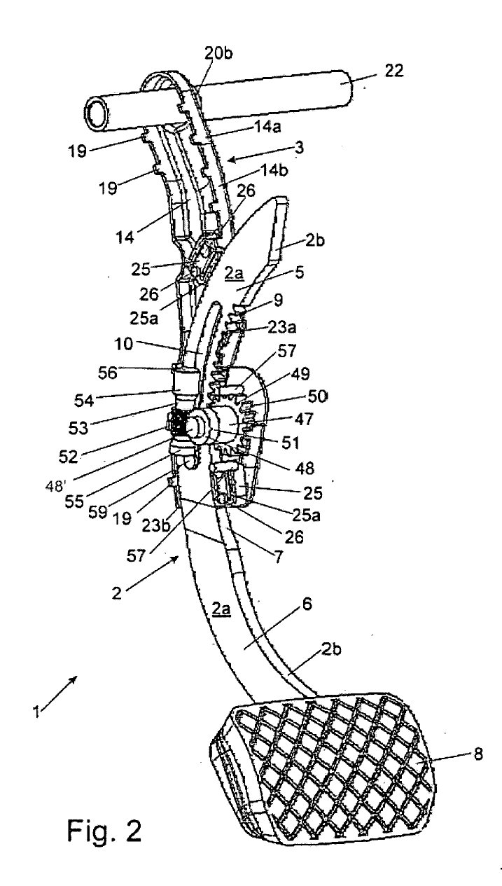

FIG. 2 shows a sectional view of the pedal from FIG. 1,

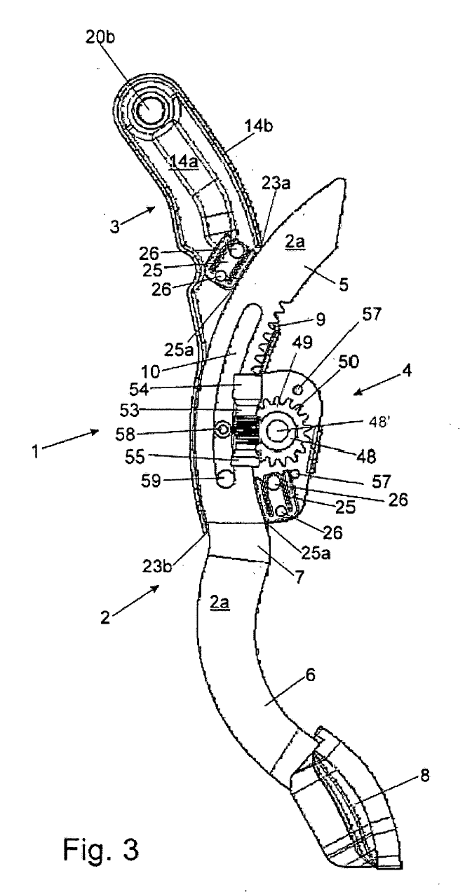

FIG. 3 shows a plan view of the pedal from FIG. 2, and

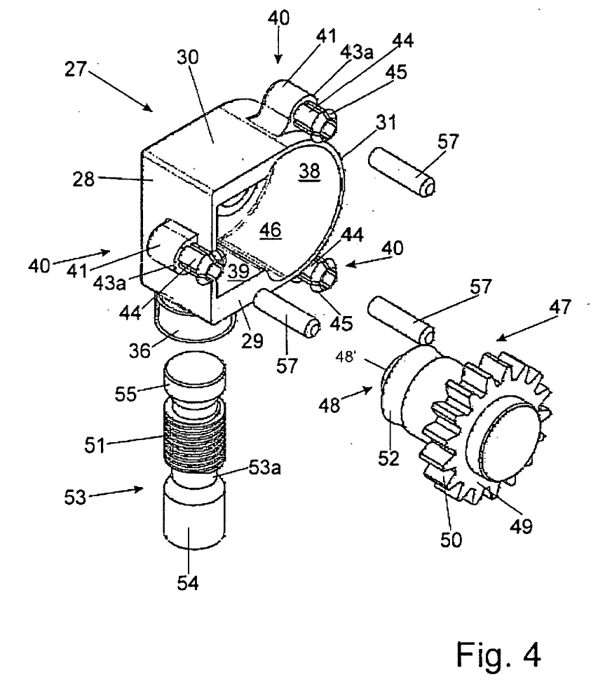

FIG. 4 shows an exploded view of the adjustment unit of the pedal from FIG. 1

FIGS. 1 to 3 show a pedal according to the invention which is embodied as a brake pedal 1 and in which a first pedal arm 2 and a second pedal arm 3 are coupled to one another by means of an adjustment unit 4, the brake pedal 1 having an extent which follows a mirror-inverted S.

The first pedal arm 2 which is embodied as a flat body with a flat side 2a and an edge side 2b is divided into an adjustment section 5, an activation section 6 and a connecting section 7, the adjustment section 5 being coupled to the second pedal arm 3 via the adjustment unit 4, and being connected by an end facing away from the adjustment unit 4 to the activation section 6 by the connecting section 7.

The activation section 6 and the adjustment section 5 each have a circular-arc-shaped extent, but one radius of the adjustment section 5 is made larger than a radius of the activation section 6, resulting in an overall shape for the first pedal arm 2 which is equal to two Cs placed one on top of the other, the connecting section 7 forming a knee between the two other sections.

At an end of the activation section 6 facing away from the connecting section 7, a tread surface 8 is attached to the edge side 2b.

The adjustment section 5 has on part of the edge side 2a a toothing 9 which has a profile which follows the curvature of the adjustment section 5. The toothing 9 extends approximately over a central region of the edge side 2a of the adjustment section 5, and an elongated hole 10 which extends in parallel with the toothing 9 is formed in a central region of the flat side 2a of the adjustment section 5.

The second pedal arm 3 which is embodied as a hollow body has a pivoting section 11 and a guide section 12, the second pedal arm 3 being formed from a first part 13 and a second part 14 which are connected to one another by a plurality of clip devices 15. The adjustment section 5 of the first pedal arm 2 is movably arranged between the two parts 13, 14.

The first part 13 of the second pedal arm 3 is formed from a flat material with a flat side 13a, eight slit-shaped openings 16 being formed in the region of the pivoting section 11 in an edge region of the flat side 13a.

The guide section 12 of the first part 13 has an essentially rectangular shape with rounded corners. Three further slit-shaped openings 16 are formed in the region of the guide section 11 in the flat side 13a, on the edge region of said section, and a U-shaped cutout 17, into which the adjustment unit 4 is inserted, is formed in a central region, three attachment bores 18 for attaching the adjustment unit 4 being formed around the cutout 17.

The second part 14 is formed from a flat material which has a U-shaped cross section, a base of the U forming a flat side 14a, and the limbs of the U forming a circumferential border 14b for the second part 14. Eight clip-shaped projections 19 are arranged in the region of the pivoting section 11 on the border 14b at an approximately equal distance from one another. A further three clip-shaped projections 19 are provided on the border 14b, in the region of the guide section 12.

A clip connection 15 is composed of, in each case, one slit-shaped opening 16 and one clip-shaped projection 19 so that the first part 13 and the second part 14 of the second pedal arm 3 are connected to one another by means of eleven clip connections 15, eight clip connections 15 being arranged on the pivoting section 11 and three clip connections 15 being arranged on the guide section 12. It goes without saying that the two parts 13 and 14 of the second pedal arm 3 can also be connected to one another by means of some other type of attachment, for example by rivets or screws.

At an end facing away from the first pedal arm 2, the first and the second parts 13 and 14 each have a bore 20a, 20b which are provided in alignment with one another. The two bores 20a and 20b together form a bearing device 21 for the second pedal arm 3 in which a bearing tube 22 is arranged.

The pivoting section 11 of the second pedal arm 3 extends in an arcuate shape with a curvature which has an opposed orientation with respect to the curvature of the adjustment section 5 of the first pedal arm 2.

The second pedal arm 3 has an interior which is formed by the flat side 13a of the first part 13, the flat side 14a of the second part 14 and the border 14b. The adjustment section 5 of the first pedal arm 2 is partially arranged in the interior, two break-throughs 23a and 23b being formed in the border 14b, the adjustment section 5 extending into the interior through the first break-through 23a, and out of the interior through the second break-through 23b.

The guide section 12 of the second pedal arm 3 has a guide 24 which is of multi-part construction and in which the adjustment section 5 of the first pedal arm 2 is arranged. The border 14 which is formed in the region of the guide section 12 forms a first part of the guide 24, the adjustment section 5 bearing against it with its edge region 2b.

In a central region of the guide section 12, a roller 58 is attached to the inside of the flat side 14a and is provided inside the elongated hole 10 and guides it. At a distance from the roller 58 a bolt 59 is arranged which is also provided in the elongated hole 10 and defines an end position for the adjustment of the first pedal arm 2.

A first rectangular guide block 25 is arranged in the region of the break-through 23a on the inside of the flat side 14a by means of two rivets 26, in such a way that one long side 25a of the guide block 25 guides the edge side 2b lying opposite the toothing 9 of the adjustment section 5. At the end of the guide section 12 which faces the first pedal arm 2, a structurally identical, further guide block 25 is provided in the region of the second break-through 23b on the inside of the flat side 14a, which guide block guides the edge side 2a with the toothing 9 in the same way.

A housing 27 which covers the cutout 17 is arranged on the flat side 13a of the first part 13, the housing 27 which is illustrated in FIG. 4, the housing having a base 28 which is embodied as a flat side, two limbs 29, 30 which are embodied as flat sides and one side 31, which lies opposite the base 28 and is formed in a semicircular shape, as edge sides. The edge sides are connected to one another by means of a first base side 32 and a second base side 33, the first base side 32 having an opening 34 and a circular depression 35 being formed in the second base side 33.

A circular projection 36 is formed on the limb 29, the projection 36 being of hollow construction and being connected to an interior cavity 37 of the housing 27.

The housing 27 is attached to the flat side 13a by means of three attachment devices 40 which is embodied in one piece with the housing 27. One of the attachment devices 40 is arranged in the center of the base 28, and one each of the attachment devices 40 is arranged on an edge region of the semicircular side 31.

Each of the attachment devices 40 is composed of a cylindrical base element 41 with an outer casing 42 and two end sides 43a, 43b, the outer casing 42 being partially flattened and being formed in one piece on the housing 27 and extending beyond the radius. On one end side 43a, four quarter-circle-shaped attachment clips 44 are provided which together form a circle and protrude beyond the base side 32 which bears against the flat side 13a, the attachment clips 44 being of elastic construction. In one end region, the attachment clips 44 have a collar 45 which is embodied on one side.

In each case one attachment clip 44 is used to attach the housing 27 to the flat side 13a of the second part 13 of the second pedal arm 3 in one of the three attachment bores 18 which are arranged around the cutout 17, a securing force for the housing 24 being provided by the elastic tensioning of the attachment clips 44. By means of the collar 45 which is formed on the attachment clips 44, the attachment clips 44 are additionally prevented from sliding back out of the attachment bores 18.

The housing 27 is formed in a half-open fashion by means of the opening 34, on the side which is in contact with the cutout 17, with the result that an internal cavity 46 of the housing 24 forms, with the part of the interior of the second pedal arm 3 which lies under the cutout 17, a common attachment space for the adjustment unit 4, the toothing 9 which is arranged on the first pedal arm 2 extending in the attachment space.

The internal cavity 37 is divided into a first region 38 which has a semicircular cross section, and a second region 39 which has a rectangular cross section.

In the first region 38, a cylindrical gearwheel element 47 with an end side 48 is rotatably arranged so as to rest on the second base side 33, a projection 48′, which comes to rest in the depression 35, being formed on the end side 48.

A gearwheel 49 is arranged on an end of the gearwheel element 47 facing away from the projection 48′. The gearwheel element 47 extends out of the opening 34 in the second base side 33, teeth 50 of the gearwheel 40 engaging in an intermeshing fashion with the toothing 9. At the end of the gearwheel element 47 which faces away from the gearwheel 49, a circumferential worm toothing 51 is formed. Three spacer elements 57 which are formed as pins are provided on the side of the gearwheel 47, the attachment clips 40 being additionally pushed onto the spacer elements 57 in order to attach the housing 27 to the brake pedal 1.

In the second region 39 of the cavity 37, a pin 53 is arranged which has, in a central region, an axially extending indent 53a, around the periphery of which a worm thread 52 is formed. The pin 53 is rotatably arranged, at the one end, with a first cylindrical end section 54 in the projection 36 which is of hollow construction, and at the other end with a second cylindrical end section 55 on the inside of the limb 30. The pin 53 extends with the first cylindrical end section 54 beyond the projection 35 and has an internal profiling 56.

The gearwheel element 47, the pin 53 and the housing 27 are provided as a separate component, the pin 53 being firstly guided by the projection 35 into the housing 27 and being secured in the first region 38 by the depression which is arranged on the inside of the limb 30. Then, the gearwheel element 47 is introduced into the housing 27, the worm toothing 51 engaging with the worm thread 52. The housing 27 is then attached to the first part 14 of the second pedal arm 3 by means of the three attachment devices 40, the attachment clips 44 being pressed into the attachment bores 18 which are arranged around the cutout 17. The teeth 50 of the gearwheel 49 engage here with the toothing 9 which is arranged on the first pedal arm 2.

The adjustment of the first pedal arm 2 with respect to the second pedal arm 3 then functions as follows:

The pin 53 is rotated in the desired direction by means of a simple tool, for example a screwdriver or a similar hand-held tool which has a fitting which fits the internal profiling 56 of the end section 54.

The worm thread 52 which is arranged on the pin 53 intermeshes with the worm toothing 51 which is arranged on the gearwheel element 47, and said worm thread 52 transmits the rotational movement of the pin 53 to the gearwheel element 47. The gearwheel 49 which is arranged on the gearwheel element 47 is thus also made to rotate, the teeth 50 of the gearwheel 49 intermeshing with the toothing 9 which is arranged on the first pedal arm 2. As a result of the intermeshing, the first pedal arm 2 is moved with respect to the second pedal arm 3, along the toothing 9, the guide 24 guiding the first pedal arm 2 during the adjustment.

As a result of the partial arrangement of the toothing 9 on the edge side 2a of the first pedal arm 2, end settings for the brake pedal 1 are predefined in both adjustment directions since adjustment is possible only in the region of the toothing 9, limitation or shortening of the adjustment distance of the first pedal arm 2 being possible by means of a corresponding arrangement of the roller 8 and of the bolt 59.

The invention has been explained in more detail above with reference to an adjustment unit 4 which comprises the pin 53 with the worm thread 52 and the gearwheel element 47 with the gearwheel 49 and the worm toothing 51. It has to be understood that the adjustment unit 4 can also have further gear mechanism elements, permitting advantageous transmission from a first gear mechanism element which is activated by a user, and from the toothing 9 which is arranged on the first pedal arm 2.

The invention has been described in more detail above with reference to an adjustment unit 4 which permits the first pedal arm 2 to be adjusted by adjustment which is brought about by the user. It has to be understood that the adjustment unit can also be supported by an external force which is brought about, for example, by an electric motor. In addition it is possible to provide for the external force to be additionally excited by specific external influences to adjust the pedal. For example, the electric motor can thus be coupled to a sensor which detects a frontal impact of the vehicle, with the result that, when there is a frontal impact, the sensor transmits a signal to the electric motor, causing the electric motor to adjust the pedal, the adjustment direction being predefined in such a way that the first pedal arm 2 is moved into a position which clears a foot well which is arranged around the pedal.

1-15. (canceled)

16. A pedal for a vehicle, comprising:
a pedal body including a first pedal arm and a second pedal arm;
an adjustment unit arranged at the pedal body and including a toothing;
an elongated hole disposed at one of the first pedal arm and the second pedal arm and oriented parallel to the toothing;
a roller disposed at the other of the first pedal arm and the second pedal arm, the roller being arranged in the elongated hole, wherein the first pedal arm is adjustable relative to the second pedal arm by intermeshing of the toothing.

17. The pedal as claimed in claim 16, wherein the toothing is curvilinear.

18. The pedal as claimed in claim 16, wherein the adjustment unit further includes a gearwheel element arranged at the second pedal arm.

19. The pedal as claimed in claim 18, wherein the adjustment unit further includes a worm thread coupled to the gearwheel element.

20. The pedal as claimed in claim 19, wherein the adjustment unit further includes a housing, the gearwheel element and the worm thread being arranged inside the housing.

21. The pedal as claimed in claim 20, wherein the housing is a single part.

22. The pedal as claimed in claim 16, wherein the second pedal arm includes a first part and a second part, and wherein the first pedal arm is disposed between said fist part and said second part.

23. The pedal as claimed in claim 16, wherein the adjustment unit includes a guide disposed at the second pedal arm.

24. The pedal as claimed in claim 23, wherein the guide is of mutli-part construction.

25. The pedal as claimed in claim 23, wherein the guide is arranged in the second pedal arm.

26. The pedal as claimed in claim 16, further comprising a tread surface disposed at the first pedal arm.

27. The pedal as claimed in claim 16, wherein the second pedal arm includes a coupling for an actuating device.

28. The pedal as claimed in claim 16, wherein the second pedal arm includes a bearing device for mounting on the vehicle.

29. The pedal as claimed in claim 16, wherein the first pedal arm is adjustable in two dimensions relative to the second pedal arm.

30. The pedal as claimed in claim 16, wherein the toothing is disposed at the first pedal arm, and wherein the first pedal arm is adjustable relative to the second pedal arm along the toothing.
